(19) United States
(12) Patent Application Publication
(10) Pub. No.: US 2026/0140278 A1
(43) Pub. Date: May 21, 2026

(54) Indoor Rockfall Motion Test Device and Ramming Structure

(71) Applicant: Guizhou Power Grid Co., Ltd., Guiyang (CN)

(72) Inventors: Yu WU, Guiyang (CN); Shuyi ZHENG, Guiyang (CN); Yi LI, Guiyang (CN); Jianrong WU, Guiyang (CN); Xiaohu ZHENG, Guiyang (CN); Jibin JIANG, Guiyang (CN); Qing LIU, Guiyang (CN); Qili ZHANG, Guiyang (CN); Huan HUANG, Guiyang (CN); Xianglun NIE, Guiyang (CN); Jie HUANG, Guiyang (CN); Rongjun HU, Guiyang (CN); Shouchang WU, Guiyang (CN); Xianyin MAO, Guiyang (CN); Qi YANG, Guiyang (CN); Yao ZHONG, Guiyang (CN); Qianyong LV, Guiyang (CN); Zhiping ZHAO, Guiyang (CN); Mengjin HU, Guiyang (CN); Kai LUO, Guiyang (CN); Lunhui YANG, Guiyang (CN); Zhanjun LIU, Guiyang (CN); Jiangshun YU, Guiyang (CN); Dandan LIU, Guiyang (CN)

(21) Appl. No.: 19/442,717

(22) Filed: Jan. 7, 2026

Related U.S. Application Data
(63) Continuation of application No. PCT/CN2024/118346, filed on Sep. 11, 2024.

(30) Foreign Application Priority Data
Nov. 16, 2023 (CN) 202311536184.9

(51) Int. Cl. G01V 99/00

(52) U.S. Cl. CPC G01V 99/00

(57) ABSTRACT

The present invention relates to the technical field of rockfall motion tests, and in particular to an indoor rockfall motion test device and a ramming structure, comprising a bearing component, comprising a support, a mounting crossbar arranged on the support, and a release assembly arranged on the mounting crossbar; and a throwing component, comprising a rockfall start section arranged on the support. In the present invention, the slope shape can be adjusted at will, different plates can be replaced for laying, and filling materials can be replaced, so as to simulate different throwing adjustments.

### CROSS-REFERENCE TO RELATED APPLICATIONS

The present application is a continuation of International Application No. PCT/CN2024/118346, filed on Sep. 11, 2024, which claims priority to Chinese Patent Application No. 202311536184.9, filed on Nov. 16, 2023, the entire disclosure of which is incorporated herein by reference.

### TECHNICAL FIELD

The present invention relates to the technical field of rockfall motion tests, and in particular to an indoor rockfall motion test device and a ramming structure.

### BACKGROUND

With the high-speed and high-quality development of economy in China, highways, water conservancy, bridges, tunnels, houses and other projects are increasingly constructed day by day, and area covered by the projects and high and steep slopes are also increasing accordingly. The number of dangerous rock masses on slopes has increased significantly, which seriously threatens lives and property of people and the safety of engineering construction. As one of main geological disasters in Southwest China, the rockfall disaster in mountainous areas has the characteristics of wide distribution, small scale, strong randomness and strong concealment. Therefore, how to effectively prevent and control the rockfall disaster has become an urgent problem to be solved.

Rockfall motion characteristics and laws are mainly studied through field test, laboratory test and numerical simulation. The field test is time-consuming and costly, and is complex and diverse in the field test condition due to the influence of environmental and topographic conditions. Therefore, indoor physical simulation test is often used as a study method. However, a current indoor rockfall motion test device is expensive to manufacture and cumbersome in process, some may be simple, but the slope pavement material is also relatively simple. A test slope constructed by conventional supports or jacks is single in shape, which cannot reflect all the modes of rockfall motion. At the same time, the soil that adjusts the stop and deposition of the test device needs to be continuously rolled and watered, relying on manual operation.

### SUMMARY

The purpose of the section is to overview some aspects of embodiments of the present invention and to briefly introduce some of preferable embodiments. In the section as well as in the abstract and title of the present application, some simplifications or omissions may be made to avoid making the purpose of the section, the abstract and the title ambiguous, but such simplifications or omissions cannot be used to limit the scope of the present invention.

In view of the above problems of single slope shapes and pavement materials, the present invention is disclosed.

Therefore, the present invention is to provide an indoor rockfall motion test device.

To solve the technical problems above, the present invention provides the following technical solutions: an indoor rockfall motion test device, including a bearing component, including a support, a mounting crossbar arranged on the support, and a release assembly arranged on the mounting crossbar; a throwing component, including a rockfall start section arranged on the support, a wheeled rail ladder arranged on one side of the rockfall start section, a rockfall throwing section arranged on the support, a dip angle adjustment member arranged on the rockfall throwing section, a fallen rock stopping and deposition section arranged on the support, and a fallen rock interception plate arranged on the support; and high-speed cameras, wherein two high-speed cameras are provided, one high-speed camera is arranged on the mounting crossbar, and the other high-speed camera is arranged on one side of the throwing component, for photographing the throwing component.

As a preferable solution of the indoor rockfall motion test device of the present invention, the rockfall start section is mounted beneath the release assembly, the rockfall start section includes two slope sections, and heights and angles of the two slope sections can be mutually adjusted.

As a preferable solution of the indoor rockfall motion test device of the present invention, the rockfall throwing section includes a stainless steel plate arranged on the support, and a concrete plate arranged on the stainless steel plate, the stainless steel plate is connected with the dip angle adjustment member, and the dip angle adjustment member is movably connected with the support. The fallen rock stopping and deposition section includes a stainless steel box and a filling material filled in the stainless steel box, and the filling material can be sandy stone, soil, and the like.

The indoor rockfall motion test device of the present invention has the beneficial effects that: the rockfall start section of the present invention includes a steel rack and a pavement plate material, the steel rack is fixed on the support, and slopes at both ends are maintained horizontally and transversely. By adjusting the sizes and splicing positions of the steel rack and the support, the length and dip angle of the rockfall start section can be designed, to provide different power conditions for rockfall motion. Compared with a conventional indoor rockfall motion test, the present invention simulates a field test environment. The rockfall throwing section of the present invention is composed of a stainless steel plate and a concrete slab, and arranged above the dip angle adjustment member of the throwing section. The angle of inclination of the rockfall throwing section can be adjusted through the dip angle adjustment member of the throwing section. By configuring prefabricated concrete slabs of different strength on the steel plate, soft and hard bed rocks of different strength can be effectively simulated. With the combination of a monitoring device, the fallen rock bumping and bouncing process can be analyzed, and bumping restore coefficients can be acquired. The fallen rock stopping and deposition section of the present invention is composed of stainless steel plates through splicing, a movable valve is mounted at the tail end on one side surface, replacement of filling materials of different water contents and particle size ratios can be achieved, so as to simulate materials in different collapse accumulation areas. The slope shape of the present invention can be adjusted at will, different plates can be replaced for laying, and filling materials can be replaced, so as to simulate different throwing adjustments, soft and hard bed racks different strength can be simulated, and different collapse accumulation areas can be simulated.

In view that in the practical use process, there is a problem that the soil in the fallen rock stopping and deposition section is inconvenient to adjust.

To solve the technical problem above, the present invention also provides the following technical solution: a ramming structure, for the indoor rockfall motion test device, further including: a stopping and deposition component, including a mounting rack arranged on the support, and an accommodating box arranged on the mounting rack; a mounting component, including a lifting and lowering assembly arranged on the mounting rack, a locking assembly arranged on the lifting and lowering assembly, and a linking assembly arranged on the locking assembly; a release component, including a mounting assembly arranged on the lifting and lowering assembly, a release assembly arranged on the mounting assembly, and a driving assembly arranged on the mounting assembly; and a ramming component, including a watering assembly arranged on the release component, and a sealing assembly arranged on the watering assembly.

As a preferable solution of the ramming structure of the present invention, the lifting and lowering assembly includes a limiting tooth arranged on the mounting rack, and a sliding sleeve arranged on the mounting rack. The locking assembly includes a limiting sleeve arranged on the sliding sleeve, a first elastic member arranged on the limiting sleeve, and a movable tooth arranged inside the limiting sleeve. The linking assembly includes an accommodating groove formed in the sliding sleeve, a first air cylinder arranged in the accommodating groove, a connecting plate arranged on the output shaft of the first air cylinder, and a connecting rod arranged on the movable tooth.

As a preferable solution of the ramming structure of the present invention, the sliding sleeve is in sliding connection with the mounting rack, the sliding sleeve is matched with the limiting tooth, the limiting sleeve is matched with the movable tooth, the movable tooth is in mutual clamp connection with the limiting tooth, both ends of the first elastic member are respectively fixedly connected with the limiting sleeve and the movable tooth, one end of the connecting rod is fixedly connected with the movable tooth, the other end extends out of the limiting sleeve and is fixedly connected with the connecting plate, and the connecting rod is in sliding connection with the limiting sleeve.

As a preferable solution of the ramming structure of the present invention, the mounting assembly includes an extending mounting plate arranged on the sliding sleeve, rotating wheels arranged on the extending mounting plate, and linking teeth arranged on the rotating wheels. Two rotating wheels are provided, and the two rotating wheels are both equipped with linking teeth which are meshed with each other.

As a preferable solution of the ramming structure of the present invention, the release assembly includes a clamping head arranged on the rotating wheels, a prolonging plate arranged on the rotating wheels, a clamping roller arranged on the prolonging plate, a limiting plate arranged on the clamping roller, and a second elastic member arranged on the prolonging plate.

As a preferable solution of the ramming structure of the present invention, the driving assembly includes a second air cylinder arranged on the sliding sleeve, and a jacking rod arranged on the output shaft of the second air cylinder. The jacking rod is matched with the clamping head; and both ends of the second elastic member are respectively fixedly connected with two prolonging plates.

As a preferable solution of the ramming structure of the present invention, the watering assembly includes a main mounting plate arranged between the release assembly, a through hole formed in the main mounting plate, a water storage tank arranged on the main mounting plate, and a fixing rod arranged on the main mounting plate. The sealing assembly includes a ramming plate arranged beneath the main mounting plate, a sealing convex arranged on the ramming plate, and a mounting bolt arranged on the ramming plate.

The ramming structure of the present invention has the beneficial effects that: due to adoption of the release component and the ramming component of the present invention, the watering assembly can be mounted above the accommodating box through the release component in use, and soil or sandy rock is arranged in the accommodating box. When dry soil needs to be watered to simulate moist soil, water can be injected into the watering assembly to simulate waterfall. When the soil needs to be rammed, the sealing assembly is tightly inserted into the watering assembly and fixed through the mounting bolt, then the watering hole of the watering assembly can be sealed, the weight of the ramming component can be adjusted through water injection at the moment, the ramming component is released from fixation through the release component, and then the ramming component falls down under the action of gravity at the moment, to tamp the soil to ram up.

### BRIEF DESCRIPTION OF DRAWINGS

In order to describe the technical solutions in the examples of the present invention more clearly, a brief description of the accompanying drawings required for describing the examples will be provided below. Obviously, the accompanying drawings in the following description show merely some examples of the present invention. Those of ordinary skill in the art can also derive other accompanying drawings from these accompanying drawings without making in creative efforts. In the figures:

FIG. 1 is an overall schematic diagram of an indoor rockfall motion test device;

FIG. 2 is an overall schematic diagram of another view of an indoor rockfall motion test device;

FIG. 3 is a schematic diagram of a release assembly of an indoor rockfall motion test device;

FIG. 4 is a structural schematic diagram of a rockfall start section of an indoor rockfall motion test device;

FIG. 5 is a structural schematic diagram of a rockfall throwing section of an indoor rockfall motion test device;

FIG. 6 is a structural schematic diagram of a fallen rock stopping and deposition section of an indoor rockfall motion test device;

FIG. 7 is an overall schematic diagram of a ramming structure;

FIG. 8 is an overall schematic diagram of a ramming structure without a watering assembly;

FIG. 9 is an enlarged view of position A in FIG. 8;

FIG. 10 is a schematic diagram of the cross section of a locking assembly of a ramming structure;

FIG. 11 is an enlarged view of position B in FIG. 8; and

FIG. 12 is a structural diagram of the cross section of a watering assembly of a ramming structure.

### DETAILED DESCRIPTION OF THE EMBODIMENTS

In order to make the above objectives, features and advantages of the present invention more obvious and understandable, specific embodiments of the present invention will be described in detail below with reference to the accompanying drawings of the specification.

A number of specific details are set forth in the description below to provide a thorough understanding for the present invention; however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

### Embodiment 1

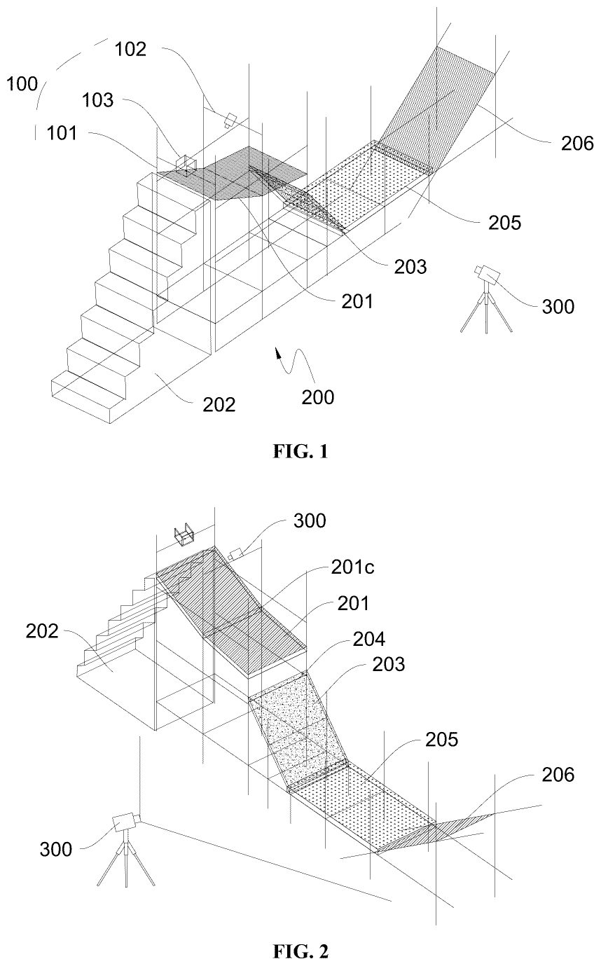

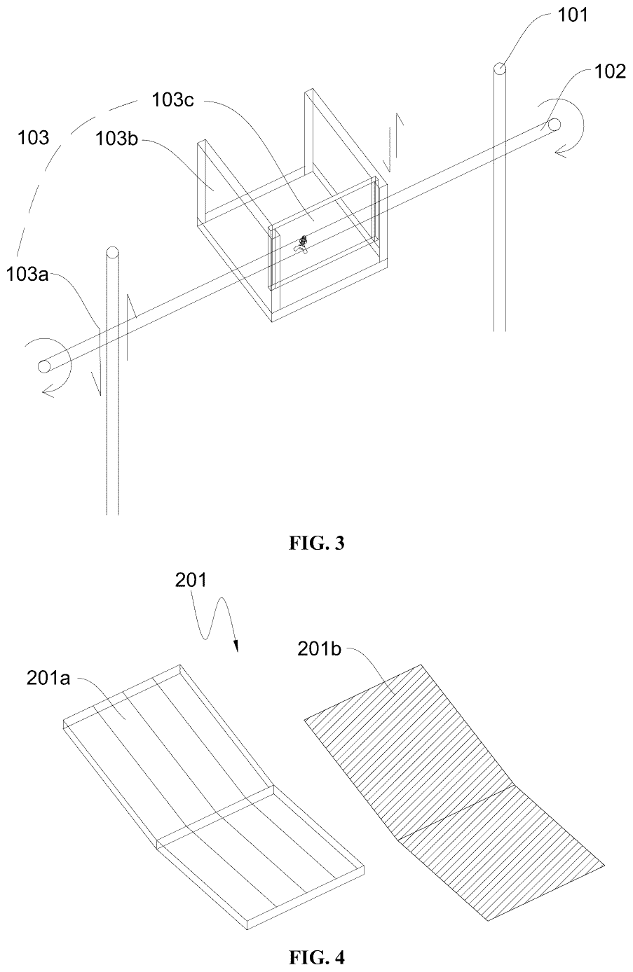

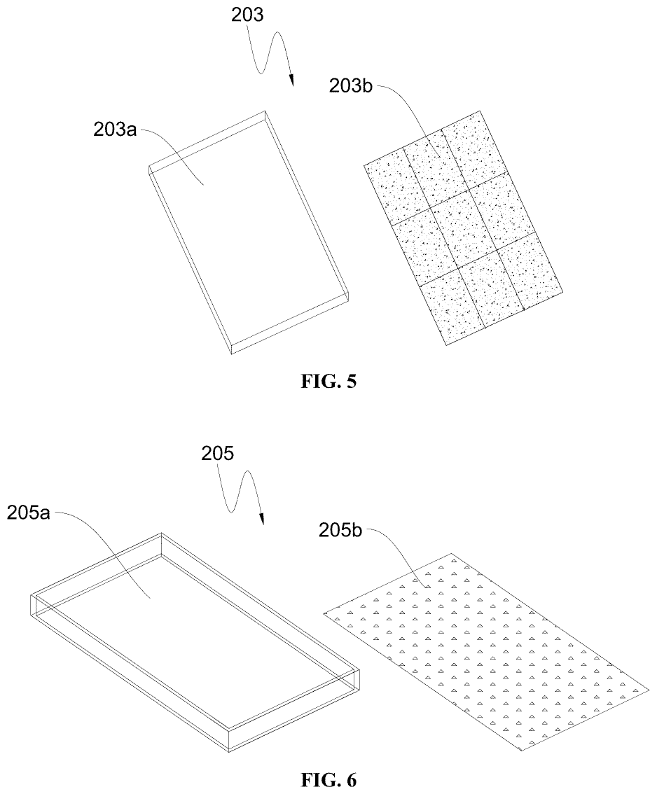

Referring to FIG. 1-6, as a first embodiment of the present invention, the embodiment provides an indoor rockfall motion test device, including a bearing component 100, including a support 101, a mounting crossbar 102 arranged on the support 101, and a release assembly 103 arranged on the mounting crossbar 102; a throwing component 200, including a rockfall start section 201 arranged on the support 101, a wheeled rail ladder 202 arranged on one side of the rockfall start section 201, a rockfall throwing section 203 arranged on the support 101, a dip angle adjustment member 204 arranged on the rockfall throwing section 203, a fallen rock stopping and deposition section 205 arranged on the support 101, and a fallen rock interception plate 206 arranged on the support 101; and high-speed cameras 300, wherein two high-speed cameras 300 are provided, one high-speed camera 300 is arranged on the mounting crossbar 102, and the other high-speed camera 300 is arranged on one side of the throwing component 200, for photographing the throwing component 200.

Specifically, the release assembly 103 includes a lifting and lowering member 103a arranged on the support 101, a bearing member 103b arranged on the lifting and lowering member 103a, and a release member 103c arranged on the bearing member 103b. The lifting and lowering member 103a only needs to play the role of lifting and lowering and locking. The bearing member 103b includes a crossbar movably connected with the lifting and lowering member 103a, and a U-shaped plate structure rotationally connected with the crossbar. Heights and angles of the bearing member 103b can be adjusted at will. The release member 103c is used for stopping fallen rock, and the fallen rock can be released after opening the release member 103c. The rockfall start section 201 is mounted beneath the release assembly 103, and slopes at both ends of the rockfall start section 201 are used for providing initial power conditions for rockfall motion before airing. The rockfall throwing section 203 is mounted beneath the rockfall start section 201, for simulating rock in a natural environment. The fallen rock stopping and deposition section 205 is mounted beneath an airing surface, and sandy rock or sandy soil of certain water contents and partical sizes is filled therein, for simulating a collapsed fallen rock deposition environment under a natural condition. An inclined stainless steel plate 203a is mounted at the tail end of the fallen rock stopping and deposition section 205, in an inclining direction opposite to the rockfall motion direction, to intercept fallen rock of great energy, and to protect test instruments and passing persons at the tail end of the test device.

Furthermore, the rockfall start section 201 is mounted beneath the release assembly 103, the rockfall start section 201 includes two slope sections, and heights and angles of the two slope sections can be mutually adjusted. The rockfall start section 201 includes a steel rack 201a and a pavement material 201b, and a U-shaped plate in the release assembly 103 is fixed on the crossbar through a bolt and nut. The rotating crossbar is capable of adjusting the release angle of the fallen rock, and the initial falling height of the fallen rock can be controlled by adjusting the tension of a fastener in the lifting and lowering member 103a. Before the fallen rock is filled, the release member 103c is arranged in the release assembly 103, the release member 103c is rapidly pulled out when the fallen rock is released, then the fallen rock falls to the rockfall start section 201 through the gravity of self, and the motion can be regarded as motion of a free falling body.

Furthermore, the rockfall throwing section 203 includes the stainless steel plate 203a arranged on the support 101, and the concrete slab 203b arranged on the stainless steel plate 203a. The stainless steel plate 203a is connected with the dip angle adjustment member 204, and the dip angle adjustment member 204 is movably connected with the support 101. Baffle plates are mounted on both sides of the rockfall start section 201, to guarantee the safety of test and passing persons around. The rockfall throwing section 203 is composed of the stainless steel plate 203a, the concrete slabs 203b or natural stone slabs through splicing, and the dip angle of the rockfall throwing section 203 is controlled through the dip angle adjustment member 204 of the throwing section. The plates on the surface of the device are laid with swallow tail-shaped long nails fixed on steel plates. Fallen rock, after falling from the rockfall start section 201, collides with the rockfall throwing section 203. The fallen rock stopping and deposition section 205 includes a stainless steel box 205a and a filling material 205b, and take the shape of a box spliced with the stainless steel plate 203a. An opening is formed in the tail end of the long side of the device. Slots are respectively adhered to both sides of the opening, and baffle plates are inserted therein, being convenient to replace the filling materials 205b in the device.

Operation process: a black and white grid curtain of a certain size can be arranged in the cross section direction of the indoor rockfall motion test device, placed behind the device, and is used to analyze the motion coordinate of a rockfall test piece in photographed images. By adjusting the position and dip angle of the steel rack 201a, the height and dip angle of the rockfall start section 201 can be controlled, to provide different power conditions for rockfall motion. By replacing materials, sliding and rolling fiction coefficients of the fallen rock on different slopes can be calculated. In addition, to prevent the fallen rock from deviation in motion direction after contact with the slope at the start section, causing threat on passing persons or surrounding facilities, tempered glass is added on both sides of the sliding plate 201c at the start section. The rockfall throwing section 203 is composed of the stainless steel plate 203a and plates through splicing, concrete slabs 203b of corresponding strength can be prefabricated or natural stone slabs are cut according to actual needs, and are spliced in certain sizes and laid on the steel plates (not less than 3 cm in thickness). Since the fallen rock has large impact when falling from an airing surface, the device, in a steep angle of 60-80 degrees, shall be equipped with fixing plates with steel nails and stone glues, so as to prevent the plates from falling off due to tense impact and vibration. The dip angle adjustment member 204 is mounted beneath the rockfall throwing section 203. According to the device, two supports 101 are connected through rotating fasteners, and meanwhile relative rotation of the two is ensured. The fallen rock stopping and deposition section 205 is horizontally arranged above a bottom support 101. The device is composed of composite plates, sand materials and a movable valve. The composite plates are spliced into a rectangular tank, the tank depth is not less than 5 cm, an opening is formed in the tail end of a side surface, an aluminum U-shaped chute is mounted on both sides of the opening, and a movable valve is manufactured according to the size of the opening. The valve is closed, then sandy stone or sandy soil is mixed in a certain ratio and put into the tank for test. The fallen rock, after hitting the airing plate, is in contact with the fallen rock stopping and deposition section 205, then the energy is dissipated rapidly, the rockfall test piece is turned into a static state from a rolling state gradually. Materials are replaced for control test, and the movable valve can be opened to improve the test efficiency.

The test process is specifically as follows: the indoor test device in a rockfall motion mode is assembled, a prefabricated rockfall test sample is placed in the release assembly 103, high-speed cameras 300 are constructed and adjusted, the cameras are powered on to acquire images, the release member 103c is rapidly pulled out, then the fallen rock makes a free falling body motion, after in contact with the rockfall start section 201, rolls or slides down, and drops off after leaving the start section, an makes an oblique projectile motion till colliding with the rockfall throwing section 203, and after collision, the fallen rock continuous the motion in a bouncing, rolling or sliding posture, and stops the motion after in contact with a bottom slope plate and rolling for a certain distance. Then a data acquisition device can be powered off. The rockfall motion process is analyzed through commercial motion image analysis software. A certain distance in an image is taken as a drift slide, the distance between key frames of objection motions is determined, and the distance is then divided by the time to obtain the motion speed of the rockfall test piece during the period, thereby calculating motion parameters of the rockfall test piece at four motion postures. The rockfall motion speed is calculated by Newtonian classical mechanics, and rockfall collision normal and tangential recovery coefficients are acquired through motion speeds before and after collision. In a similar way, sliding friction coefficients and rolling friction coefficients of the rockfall test piece can be calculated with motion parameters of the rockfall on the rockfall start section 201 and the fallen rock stopping and deposition section 205, and the motion characteristic parameter calculation equation is as follows:

$$\{ \begin{matrix}{v}_{it} = {v}_{0 x} cos α + {v}_{0 y} sin α \\ {v}_{in} = - {v}_{0 x} cos α + {v}_{0 y} cos α\end{matrix}$$

$$\{ \begin{matrix}{v}_{bt} = {v}_{ix} sin α + {v}_{iy} cos α \\ {v}_{bn} = {v}_{ix} cos α - {v}_{iy} sin α\end{matrix}$$

$$\{ \begin{matrix}{v}_{bt} = {v}_{it} {R}_{t} \\ {v}_{bn} = {v}_{in} {R}_{n} \\ {v}_{b} = {v}_{i} R\end{matrix}$$

In the equation, vi is an impact speed before collision, vb is a bouncing speed after collision, a is a slope angle, vit is a tangential impact angle, vbt is a tangential bouncing speed, vin is a normal impact angle, von is a normal bouncing speed, t is the time, Rt is a tangential recovery coefficient, Rn is a normal recovery coefficient, and R is a collision recovery coefficient.

$$B = \frac{m}{m + \frac{I}{{R}^{2}}}$$

$$v = \sqrt{{{v}_{0}}^{2} + 2 Bg cos α ( tan α - tan {β}_{r} ) s}$$

$${μ}_{r} = tan {β}_{r} = tan α - \frac{{v}^{2} - {v}_{0}^{2}}{2 Bgs cos α}$$

$$v = \sqrt{{v}_{0}^{2} + 2 gH ( 1 - f cos α )}$$

In the equation, v0 is a motion speed at the moment, v is a motion speed of a next moment, B is a constant related to the quality and shape of the fallen rock, R is an equivalent radius, μr is a rolling friction coefficient, βr is a rolling friction angle, s is a motion distance of a fallen rock rolling section, f is a sliding friction coefficient, and H is a sliding height difference.

### Embodiment 2

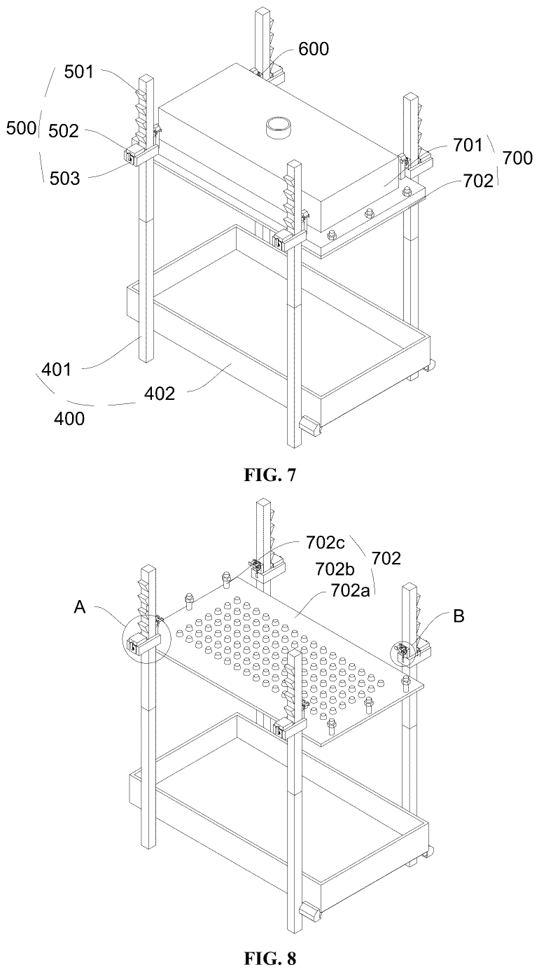

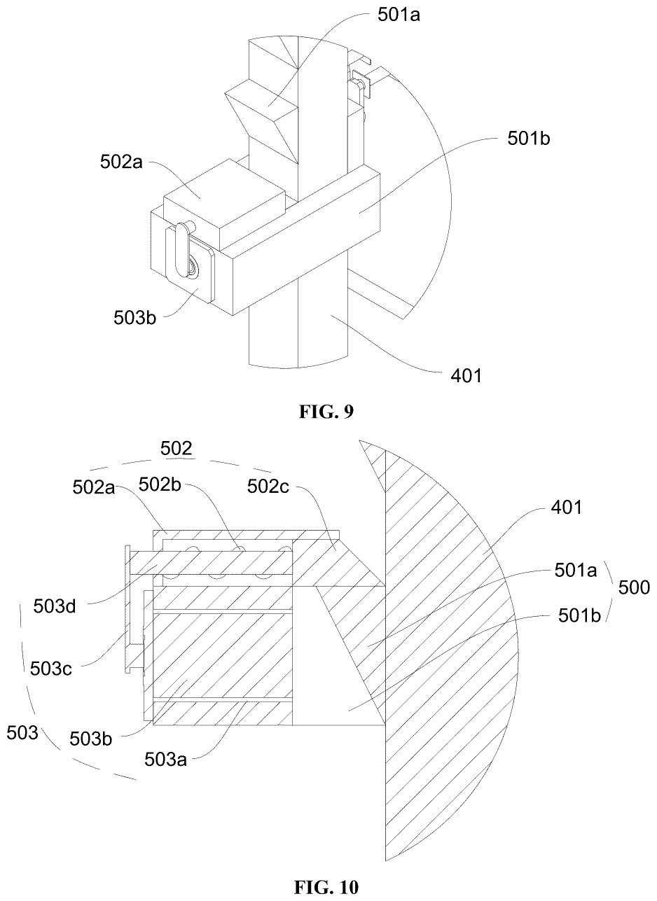

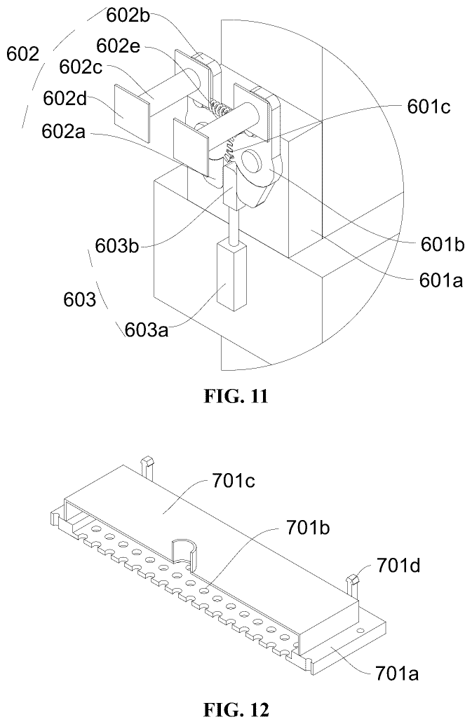

Referring to FIG. 7-12, as a second embodiment of the present invention, the difference from the previous embodiment is that a ramming structure is provided, for the indoor rockfall motion test device, including: a stopping and deposition component 400, including a mounting rack 401 arranged on the support 101, and an accommodating box 402 arranged on the mounting rack 401; a mounting component 500, including a lifting and lowering assembly 501 arranged on the mounting rack 401, a locking assembly 502 arranged on the lifting and lowering assembly 501, and a linking assembly 503 arranged on the locking assembly 502; a release component 600, including a mounting assembly 601 arranged on the lifting and lowering assembly 501, a release assembly 602 arranged on the mounting assembly 601, and a driving assembly 603 arranged on the mounting assembly 601; and a ramming component 700, including a watering assembly 701 arranged on the release component 602, and a sealing assembly 702 arranged on the watering assembly 701.

Specifically, the stopping and deposition component 400 is used for holding fallen rock, the mounting rack 401 is used for mounting and fixing the accommodating box 402, the accommodating box 402 is filled with sandy stone or soil, the lifting and lowering assembly 501 is used for controlling the mounting height of the ramming component 700, the release component 600 is capable of fixing the ramming component 700 and releasing the ramming component 700 when needing to ram the soil, and the ramming component 700 can be used for watering at the same time, thereby changing the water content of the sandy stone or soil in the accommodating box 402.

Furthermore, the lifting and lowering assembly 501 includes the limiting tooth 501a arranged on the mounting rack 401, and the limiting sleeve 501b arranged on the mounting rack 401. The locking assembly 502 includes the limiting sleeve 502a arranged on the sliding sleeve 501b, the first elastic member 502b arranged on the limiting sleeve 502a, and the movable tooth 502c arranged inside the limiting sleeve 502a. The linking assembly 503 includes the accommodating groove 503a formed in the sliding sleeve 501b, the first air cylinder 503b arranged in the accommodating groove 503a, the connecting plate 503c arranged on the output shaft of the first air cylinder 503b, and the connecting rod 503d arranged on the movable tooth 502c. Multiple limiting teeth 501a are fixedly arranged. The sliding sleeve 501b is capable of sliding up and down along the mounting rack 401, and the limiting teeth 501a do not affect the sliding sleeve 501b during sliding. The first elastic member 502b is capable of jacking out the movable teeth 502c arranged in the limiting sleeve 502a, a part of the movable teeth 502c jacked out can be clamped on the limiting tooth 501a, and then the sliding sleeve 501b can be fixed. A sliding hole is formed in a side surface of the limiting sleeve 502a, the connecting rod 503d is in sliding match with the sliding hole, the first air cylinder 503b is capable of controlling the connecting rod 503d to move through the connecting rod 503d, the connecting rod 503d pulls the movable tooth 502c back into the limiting sleeve 502a when being jacked out by the first air cylinder 503b, then the sliding sleeve 501b is unlocked at the moment, and then the sliding sleeve 501b can slide up and down to adjust the position.

Furthermore, the sliding sleeve 501b is in sliding connection with the mounting rack 401, the sliding sleeve 501b is matched with the limiting tooth 501a, the limiting sleeve 502a is matched with the movable tooth 502c, the movable tooth 502c is in mutual clamp connection with the limiting tooth 501a, both ends of the first elastic member 502b are respectively fixedly connected with the limiting sleeve 502a and the movable tooth 502c, one end of the connecting rod 503d is fixedly connected with the movable tooth 502c, the other end extends out of the limiting sleeve 502a and is fixedly connected with the connecting plate 503c, the connecting rod 503d is in sliding connection with the limiting sleeve 502a, and the limiting sleeve 502a is arranged on the outer side of the mounting rack 401.

The remaining structures are the same as in Embodiment 1.

Operation process: in use, firstly the movable teeth 502c are moved inside the limiting sleeve 502a through the first air cylinders 503b, the sliding sleeves 501b are moved to required positions, the first air cylinders 503b are controlled to retract, then the movable teeth 502c extend out, a part of the movable teeth 502c are still in the limiting sleeve 502a after extending out, at the moment, the movable teeth 502c can be mutually clamped with the limiting teeth 501a to prevent the movable sleeve to drop off, that is, the ramming component 700 can be mounted on the mounting rack 401 through the sliding sleeves 501b.

### Embodiment 3

Referring to FIG. 8-12, as a third embodiment of the present invention, the difference from the previous embodiment is that, further including a mounting assembly 601, including an extending mounting plate 601a arranged on the sliding sleeve 501b, rotating wheels 601b arranged on the extending mounting plate 601a, and linking teeth 601c arranged on the rotating wheels 601b. Two rotating wheels 601b are provided, and the two rotating wheels 601b are both equipped with linking teeth 601c which are meshed with each other.

Specifically, the extending mounting plate 601a is arranged on the inner side surface of the mounting rack 401, the rotating wheels 601b are rotationally connected with the extending mounting plate 601a, the two rotating wheels 601b are equipped with linking teeth 601c, and then the two rotating wheels 601b can move synchronously.

Furthermore, the release assembly 602 includes a clamping head 602a arranged on the rotating wheels 601b, a prolonging plate 602b arranged on the rotating wheels 601b, a clamping roller 602c arranged on the prolonging plate 602b, a limiting plate 602d arranged on the clamping roller 602c, and a second elastic member 602e arranged on the prolonging plate 602b. Both ends of the second elastic member 602e jack out the prolonging plate 602b to both sides, then the clamping rollers 602c are moved away from each other at the moment, and the clamping heads 602a are close to each other. The limiting plate 602d is used for limiting the mounting position of the ramming component 700, to prevent the ramming component 700 from colliding the release assembly 602 when dropping down.

Furthermore, the driving assembly 603 includes a second air cylinder 603a arranged on the sliding sleeve 501b, and a jacking rod 603b arranged on the output shaft of the second air cylinder 603a. The jacking rod 603b is matched with the clamping head 602a, and both ends of the second elastic member 602e are respectively fixedly connected with two prolonging plates 602b. The jacking rod 603b is capable of inserting between the two clamping heads 602a, then the two clamping heads 602a are moved away from each other, and the two clamping rollers 602c are close to each other, so as to compress the second elastic member 602e.

Furthermore, the watering assembly 701 includes a main mounting plate 701a arranged between the release assembly 602, a through hole 701b formed in the main mounting plate 701a, a water storage tank 701c arranged on the main mounting plate 701a, and a fixing column 701d arranged on the main mounting plate 701a. The sealing assembly 702 includes a ramming plate 702a arranged beneath the main mounting plate 701a, a sealing convex 702b arranged on the ramming plate 702a, and a mounting bolt 702c arranged on the ramming plate 702a. The through hole 701b is formed beneath the water storage tank 701c. The water storage tank 701c can water down to change the water content of soil when filled with water, when watering is not required, the ramming plate 702a is inserted from a lower direction, and the sealing convexes 702b are inserted into the through holes 701b to seal the through holes 701b. The ramming plate 702a is fixed on the main mounting plate 701a through the mounting bolt 702c, the main mounting plate 701a is fixed on the release assembly 602 through the fixing columns 701d, the top end of the fixing column 701d takes the shape of trapezoid, and is clamped on the clamping roller 602c.

The remaining structures are the same as in Embodiment 2.

Operation process: when the main mounting plate 701a is mounted, the fixing columns 701d are aligned to the clamping rollers 602c, and the fixing rods 701d are inserted into the clamping rollers 602c from bottom to top. During insertion, the second air cylinders 603a are retracted, then the jacking rod 603a are dissociated from the clamping heads 602a, and then can be inserted into the fixing columns 701d. When the fixing columns 701d pass through the clamping rollers 602c, the second air cylinder 603a jacks off the jacking rod 603b, the jacking rods 603b are inserted into the clamping heads 602a, then the rotating wheels 601b rotate, and the clamping rollers 602c are close to each other to clamp the bottoms of the fixing columns 701d, thereby fixing the main mounting plate 701a. When watering is needed to simulate rainfall, water can be injected into the water storage tank 701c to water the accommodating box 402 below through the through holes 701b. When soil needs to be rammed, first whether there is water in the water storage tank 701c is determined, then the ramming plate 702a is inserted into the main mounting plate 701a from bottom to top, and the mounting bolts 702c penetrate through the main mounting plate 701a and are fixed through screw nuts. The sealing convexes 702b are inserted into the through holes 701b to seal, the sealing convexes 702b are made of deformable materials such as rubber, and the sealing convexes 702b are in interference fit with the through holes 701b. After mounting, the second air cylinders 603a are retracted from the through holes 701b, then the clamping rollers 602c are moved away from each other, the fixing columns 701d are released, and the main mounting plate 701a can tamp down as a free falling body, so as to ram the soil. If the ramming power needs to be adjusted, water can be injected into the water storage tank 701c, and then the weight of the main mounting plate 701a can be increased.

It is important to note that the construction and arrangement of the present application shown in multiple different exemplary embodiments are only illustrative. Although only several embodiments are described in detail in the disclosure, those who refer to the disclosure should easily understand that many modifications are possible (such as the size, scale, structure, shape and proportion of various elements, parameter values (such as temperature and pressure), installation and arrangement, use of materials, colors, and directional changes), without deviating from the novel teachings and advantages of the subject matter described in the application. For example, elements shown as integrally formed may be composed of multiple portions or elements, positions of the elements may be inverted or otherwise changed, and the properties or number or position of discrete elements may be changed or altered. Therefore, all such modifications are intended to fall within the scope of the present invention. The order or sequence of any process or method step may be changed or reordered according to alternative embodiments. In the claims, any provision of “device plus function” is intended to cover the structure described herein that performs the function, and is not only structurally equivalent but also equivalent. Other substitutions, modifications, changes, and omissions may be made in the design, operation status, and arrangement of the exemplary embodiments without departing from the scope of the present invention. Therefore, the present invention is not limited to specific embodiments, but extends to various modifications that still fall within the scope of the appended claims.

Moreover, in order to provide concise descriptions of the exemplary embodiments, all features (namely, those features unrelated to the currently considered optimal mode of executing the present invention, or those features unrelated to the implementation of the present invention) of the actual embodiments may not be described.

It should be understood that in the development process of any practical implementation, such as in any engineering or design project, a large number of specific implementation decisions can be made. Such development efforts may be complex and time-consuming, but for ordinary technical personnel who benefit from the disclosure, excessive experimentation is not required, and the development efforts will be a routine task of design, manufacturing, and production.

It should be noted that the above embodiments are merely used for illustrating, but not limiting, the technical solutions of the present invention. Although the present invention is described in detail with reference to preferred embodiments, those of ordinary skill in the art should understand that the technical solutions of the present invention can be modified or equivalently substituted without departing from the spirit and scope of the technical solutions of the present invention, and all the modifications and equivalent substitutions should fall within the scope of the claims of the present invention.

What is claimed is:

1. An indoor rockfall motion test device, comprising:
a bearing component, comprising a support, a mounting crossbar arranged on the support, and a release assembly arranged on the mounting crossbar;
a throwing component, comprising a rockfall start section arranged on the support, a wheeled rail ladder arranged on one side of the rockfall start section, a rockfall throwing section arranged on the support, a dip angle adjustment member arranged on the rockfall throwing section, a fallen rock stopping and deposition section arranged on the support, and a fallen rock interception plate arranged on the support; and
high-speed cameras, wherein two high-speed cameras are provided, one high-speed camera is arranged on the mounting crossbar, and the other high-speed camera is arranged on one side of the throwing component, for photographing the throwing component.

2. The indoor rockfall motion test device according to claim 1, wherein the rockfall start section is mounted beneath the release assembly, the rockfall start section comprises two slope sections, and heights and angles of the two slope sections can be mutually adjusted.

3. The indoor rockfall motion test device according to claim 1, wherein the rockfall throwing section comprises a stainless steel plate arranged on the support, and a concrete plate arranged on the stainless steel plate, the stainless steel plate is connected with the dip angle adjustment member, and the dip angle adjustment member is movably connected with the support.

4. A ramming structure, for the indoor rockfall motion test device according to claim 3, further comprising:
a stopping and deposition component, comprising a mounting rack arranged on the support, and an accommodating box arranged on the mounting rack;
a mounting component, comprising a lifting and lowering assembly arranged on the mounting rack, a locking assembly arranged on the lifting and lowering assembly, and a linking assembly arranged on the locking assembly;
a release component, comprising a mounting assembly arranged on the lifting and lowering assembly, a release assembly arranged on the mounting assembly, and a driving assembly arranged on the mounting assembly; and
a ramming component, comprising a watering assembly arranged on the release assembly, and a sealing assembly arranged on the watering assembly.

5. The ramming structure according to claim 4, wherein the lifting and lowering assembly comprises a limiting tooth arranged on the mounting rack, and a sliding sleeve arranged on the mounting rack;
the locking assembly comprises a limiting sleeve arranged on the sliding sleeve, a first elastic member arranged on the limiting sleeve, and a movable tooth arranged inside the limiting sleeve;
the linking assembly comprises an accommodating groove formed in the sliding sleeve, a first air cylinder arranged in the accommodating groove, a connecting plate arranged on the output shaft of the first air cylinder, and a connecting rod arranged on the movable tooth.

6. The ramming structure according to claim 5, wherein the sliding sleeve is in sliding connection with the mounting rack, the sliding sleeve is matched with the limiting tooth, the limiting sleeve is matched with the movable tooth, the movable tooth is in mutual clamp connection with the limiting tooth, both ends of the first elastic member are respectively fixedly connected with the limiting sleeve and the movable tooth, one end of the connecting rod is fixedly connected with the movable tooth, the other end extends out of the limiting sleeve and is fixedly connected with the connecting plate, and the connecting rod is in sliding connection with the limiting sleeve.

7. The ramming structure according to claim 6, wherein the mounting assembly comprises an extending mounting plate arranged on the sliding sleeve, rotating wheelsarranged on the extending mounting plate, and linking teeth arranged on the rotating wheels;
two rotating wheels are provided, and the two rotating wheels are both equipped with linking teeth which are meshed with each other.

8. The ramming structure according to claim 7, wherein the release assembly comprises a clamping head arranged on the rotating wheels, a prolonging plate arranged on the rotating wheels, a clamping roller arranged on the prolonging plate, a limiting plate arranged on the clamping roller, and a second elastic member arranged on the prolonging plate.

9. The ramming structure according to claim 8, wherein the driving assembly comprises a second air cylinder arranged on the sliding sleeve, and a jacking rod arranged on the output shaft of the second air cylinder; the jacking rod is matched with the clamping head; and both ends of the second elastic member are respectively fixedly connected with two prolonging plates.

10. The ramming structure according to claim 9, wherein the watering assembly comprises a main mounting plate arranged between the release assembly, a through hole formed in the main mounting plate, a water storage tank arranged on the main mounting plate, and a fixing rod arranged on the main mounting plate;
the sealing assembly comprises a ramming plate arranged beneath the main mounting plate, a sealing convex arranged on the ramming plate, and a mounting bolt arranged on the ramming plate.
